(19) United States
(12) Patent Application Publication
(10) Pub. No.: US 2026/0190032 A1
(43) Pub. Date: Jul. 2, 2026

(54) WAKE-UP SIGNALS FOR ENERGY HARVESTING DEVICES

(71) Applicant: QUALCOMM Incorporated, San Diego, CA (US)

(72) Inventors: Xiaojie Wang, Hillsborough, NJ (US); Luanxia Yang, Beijing (CN); Junyi Li, Greentown, PA (US)

(21) Appl. No.: 19/129,944

(22) PCT Filed: Jan. 9, 2023
(86) PCT No.: PCT/CN2023/071158

§ 371 Date: May 14, 2025

(51) Int. Cl. H04W 52/02; H04L 27/26

(52) U.S. Cl. CPC H04W 52/0235; H04L 27/261; H04W 52/0245

(57) ABSTRACT

This disclosure provides systems, methods, and apparatuses, including computer programs encoded on computer storage media, for wireless communication. For example, a UE may receive a wake-up signal including an indication that the wake-up signal is addressed to the UE. The indication may be associated with one or more characteristics of an energy harvesting circuit of the UE. The UE may monitor, in response to the indication that the wake-up signal is addressed to the UE, one or more resources. Other aspects and features are also claimed and described.

### TECHNICAL FIELD

Aspects of the present disclosure relate generally to wireless communication systems, and more particularly, to wake-up signals for energy harvesting devices.

### DESCRIPTION OF THE RELATED TECHNOLOGY

Wireless communications systems are widely deployed to provide various types of communication content such as voice, video, packet data, messaging, broadcast, and so on. A wireless multiple-access communications system may include a number of base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

One consideration in design of UEs for use in a wireless network context is power consumption. UEs may, for example, operate without a connection to an external power source, and internal power storage of such UEs may be limited. Some UEs, such as internet of things (IOT) devices, may have limited internal power storage capacity due to design focused on reduced form factor or cost. Monitoring for signal transmissions from a network entity, such as a base station, constantly, or even periodically, may be inefficient and may cause a UE to use more power than may be required to maintain connection to the network.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a method for wireless communication performed by a user equipment (UE). The method includes receiving, from a network entity, a wake-up signal including a first indication that the wake-up signal is addressed to the UE, wherein the first indication is associated with one or more characteristics of an energy harvesting circuit of the UE and monitoring, in response to the first indication that the wake-up signal is addressed to the UE, one or more first resources.

Another innovative aspect of the subject matter described in this disclosure can be implemented in a UE. The UE includes at least one processor and a memory coupled with the at least one processor. The at least one processor is operable to receive, from a network entity, a wake-up signal including a first indication that the wake-up signal is addressed to the UE, wherein the first indication is associated with one or more characteristics of an energy harvesting circuit of the UE and monitor, in response to the first indication that the wake-up signal is addressed to the UE, one or more first resources.

Another innovative aspect of the subject matter described in this disclosure can be implemented in an apparatus configured for wireless communication. The apparatus includes means for receiving, from a network entity, a wake-up signal including a first indication that the wake-up signal is addressed to a UE, wherein the first indication is associated with one or more characteristics of an energy harvesting circuit of the UE and means for monitoring, in response to the first indication that the wake-up signal is addressed to the UE, one or more first resources.

Another innovative aspect of the subject matter described in this disclosure can be implemented in a non-transitory computer-readable medium storing instructions that, when executed by a processor, cause the processor to perform operations including receiving, from a network entity, a wake-up signal including a first indication that the wake-up signal is addressed to the UE, wherein the first indication is associated with one or more characteristics of an energy harvesting circuit of the UE and monitoring, in response to the first indication that the wake-up signal is addressed to the UE, one or more first resources.

Another innovative aspect of the subject matter described in this disclosure can be implemented in a method for wireless communication performed by a base station. The method includes receiving, from a UE, a first indication of one or more characteristics of an energy harvesting circuit of the UE and transmitting, to the UE, a wake-up signal including a second indication that the wake-up signal is addressed to the UE, wherein the first indication is associated with the one or more characteristics of the energy harvesting circuit of the UE.

Another innovative aspect of the subject matter described in this disclosure can be implemented in a base station. The base station includes at least one processor and a memory coupled with the at least one processor. The at least one processor is operable to receive, from a UE, a first indication of one or more characteristics of an energy harvesting circuit of the UE and transmit, to the UE, a wake-up signal including a second indication that the wake-up signal is addressed to the UE, wherein the first indication is associated with the one or more characteristics of the energy harvesting circuit of the UE Another innovative aspect of the subject matter described in this disclosure can be implemented in an apparatus configured for wireless communication. The apparatus includes means for receiving, from a UE, a first indication of one or more characteristics of an energy harvesting circuit of the UE and means for transmitting, to the UE, a wake-up signal including a second indication that the wake-up signal is addressed to the UE, wherein the first indication is associated with the one or more characteristics of the energy harvesting circuit of the UE.

Another innovative aspect of the subject matter described in this disclosure can be implemented in a non-transitory computer-readable medium storing instructions that, when executed by a processor, cause the processor to perform operations including receiving, from a UE, a first indication of one or more characteristics of an energy harvesting circuit of the UE and transmitting, to the UE, a wake-up signal including a second indication that the wake-up signal is addressed to the UE, wherein the first indication is associated with the one or more characteristics of the energy harvesting circuit of the UE.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram of an example energy harvesting device according to one or more aspects.

FIG. 4 is a circuit schematic of an example energy harvesting circuit according to one or more aspects.

FIG. 5 is a block diagram illustrating an example wireless communication system that supports wake-up signal functionality for energy harvesting devices according to one or more aspects.

FIG. 6 is an example graph of power profiles of a plurality of energy harvesting circuits according to one or more aspects.

FIGS. 7A-7C are timing diagrams of an example wake-up signal according to one or more aspects.

FIGS. 8A-8B are timing diagrams of an example wake-up signal according to one or more aspects.

FIGS. 9A-9C are timing diagrams of an example wake-up signal according to one or more aspects.

FIGS. 10A-10L are timing diagrams of an example wake-up signal according to one or more aspects.

FIGS. 11A-B are flow diagrams illustrating example processes that support wake-up signal functionality for energy harvesting devices according to one or more aspects.

FIGS. 12A-B are flow diagrams illustrating example processes that support wake-up signal functionality for energy harvesting devices according to one or more aspects.

FIG. 13 is a block diagram of an example UE that supports wake-up signal functionality for energy harvesting devices according to one or more aspects.

FIG. 14 is a block diagram of an example base station that supports wake-up signal functionality for energy harvesting devices according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The present disclosure provides systems, apparatus, methods, and computer-readable media for wake-up signal functionality for energy harvesting devices. Energy harvesting devices, such as user equipments (UEs) with energy harvesting functionality, may include limited onboard power storage. Wake-up signals may be used to cause UEs with energy harvesting functionality to monitor one or more resources for transmission of information from a base station. For example, a wake-up signal transmitted to and received by a UE with energy harvesting functionality may include an indication that the wake-up signal is addressed to the UE. Such an indication may be in the form of a particular pattern or sequence (used interchangeable herein) of power levels of the wake-up signal. In some other examples, the indication may take the form of a sequence, such as an amplitude shifting key sequence, that is included in the wake-up signal. Based on receipt of a wake-up signal that is addressed to the receiving UE, the UE may monitor one or more resources, such as a physical downlink control channel (PDCCH), for transmission of information from a base station. Such monitoring may, for example, entail exiting a low power mode.

Particular implementations of the subject matter described in this disclosure can be implemented to realize one or more of the following potential advantages. In some aspects, the described techniques enable reduced power consumption by energy harvesting UEs. For example, an energy harvesting UE may refrain from monitoring one or more resources, such as a PDCCH, until a wake-up signal addressed to the UE is received by the UE. For example, the UE may remain in a low power mode until a wake-up signal is received by the UE, instead of waking and monitoring one or more resources for a transmission from a base station for predetermined periods of time. Thus, power consumption by the UE may be reduced as the UE may monitor one or more resources only when a wake-up signal is received. Furthermore, such a reduction in power consumption may allow for energy harvesting UEs with reduced form factor or cost to be produced incorporating reduced power consumption and, by extension, reduced need for energy storage in UE designs. Indication of an energy harvesting UE to which a wake-up signal is addressed using a sequence detectable by an envelope detector, such as a passive envelope detector, may facilitate reduced cost and power consumption due to low envelope detector costs and low power consumption by an envelope detector. Indication of an energy harvesting UE to which a wake-up signal is addressed using a pattern of power levels of the wake-up signal may also allow for reduced UE cost and power consumption due to use of an energy harvesting circuit of the UE for detection of such a pattern in the wake-up signal.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. In some implementations, two or more wireless communications systems, also referred to as wireless communications networks, may be configured to provide or participate in authorized shared access between the two or more wireless communications systems.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ˜1M nodes per km2), ultra-low complexity (such as ˜10s of bits per sec), ultra-low energy (such as ˜10+ years of battery life), and deep coverage with the capability to reach challenging locations; (2) including mission-critical control with strong security to safeguard sensitive personal, financial, or classified information, ultra-high reliability (such as ˜99.9999% reliability), ultra-low latency (such as ˜1 millisecond (ms)), and users with wide ranges of mobility or lack thereof; and (3) with enhanced mobile broadband including extreme high capacity (such as ˜10 Tbps per km2), extreme data rates (such as multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

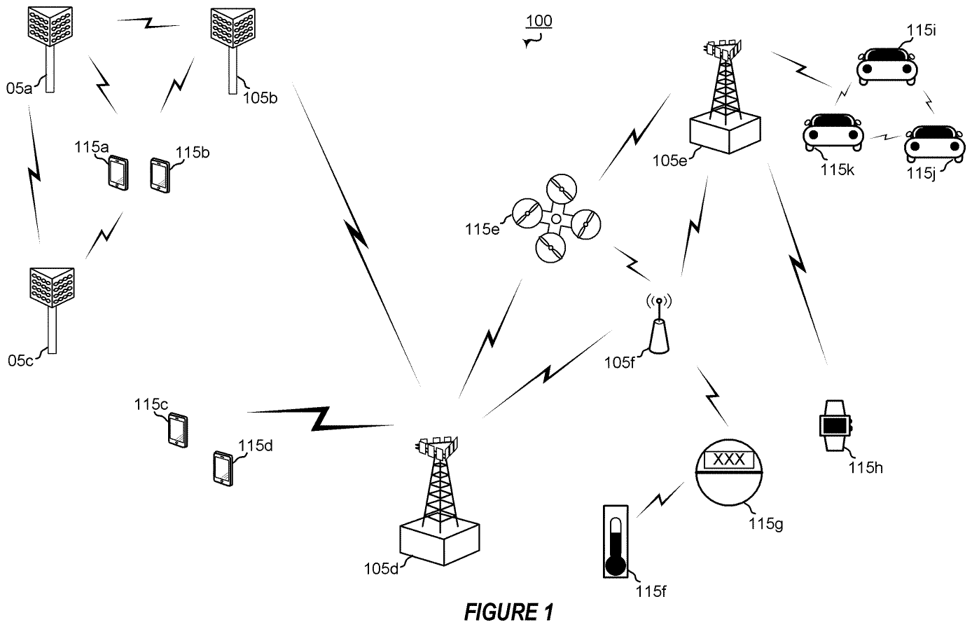

FIG. 1 is a block diagram illustrating details of an example wireless communication system. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (COMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

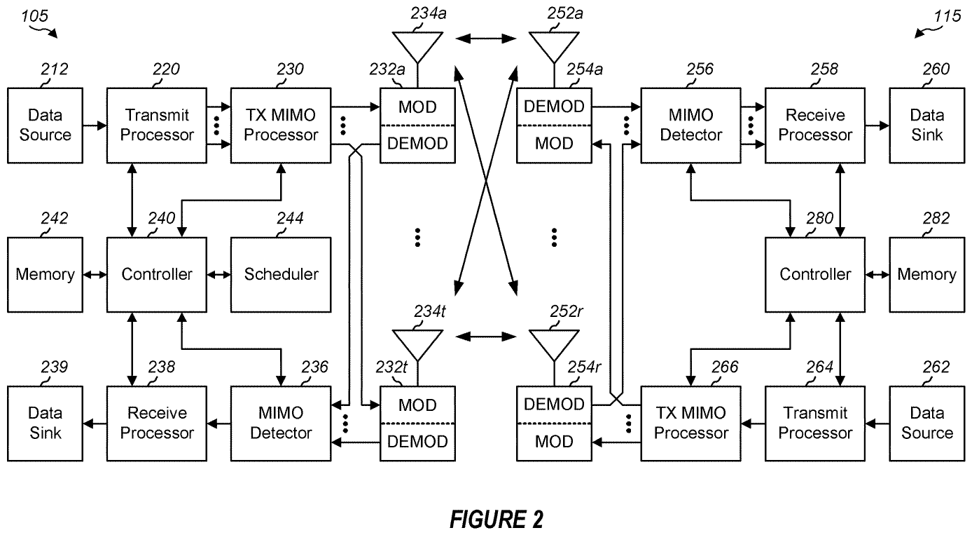

FIG. 2 is a block diagram conceptually illustrating an example design of a base station 105 and a UE 115. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f. Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a controller 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a controller 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the controller 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the controller 240.

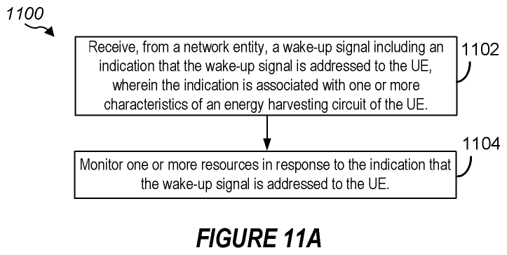

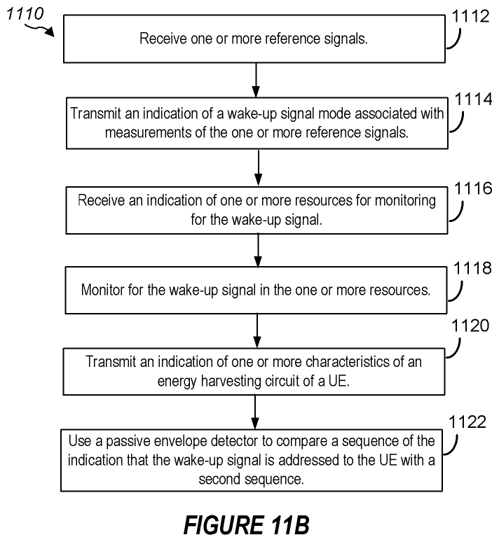

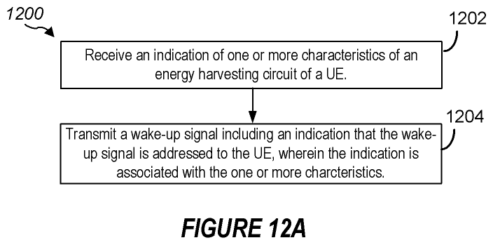

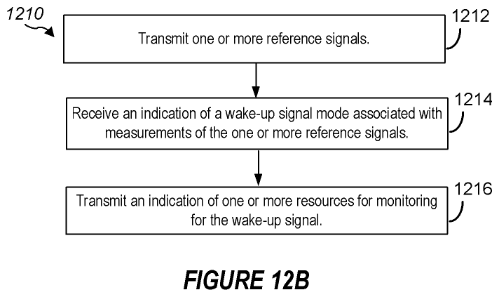

The controllers 240 and 280 may direct the operation at the base station 105 and the UE 115, respectively. The controller 240 or other processors and modules at the base station 105 or the controller 280 or other processors and modules at the UE 115 may perform or direct the execution of various processes for the techniques described herein, such as to perform or direct the execution illustrated in FIGS. 11 and 12, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

Wireless communication networks, such as wireless network 100 of FIG. 1 or other 5G, 6G, or other wireless communication networks, may support a wireless energy transfer service to transfer energy from one or more energy transmitters, such as network entities, to one or more energy receivers, such as UEs with energy harvesting functionality. An energy transfer service over a wireless network may allow UEs to operate one or more components using energy transmitted by network entities over a wireless network and may allow UEs to store energy in one or more energy storage components, such as batteries or capacitors, for future usage. Such energy transfer capabilities may be particularly useful in embodiments where UEs include radio frequency identification (RFID) devices, such as IoT devices, with limited or no internal power storage capacity. For example, energy transfer over a wireless network may allow UEs including RFID tags, such as IoT devices or other UEs, to be designed with little or no internal power storage capacity which may reduce a cost of the UEs, allow UEs to be produced with smaller form factors, and allow UEs to continue to operate even when internal power storage is depleted.

UEs with energy harvesting functionality may include radio frequency energy harvesting circuitry, such as RFID circuitry, for harvesting of wireless energy over the air such as through transmission from one or more entities, such as one or more base stations. Wireless energy transmission signals in such applications may be backscatter modulated. As one particular example, RFID technology is rapidly growing in use, with applications in inventory/asset management inside and outside warehouses, IoT, sustainable sensor networks for factories and/or agriculture, and smart homes. RFID circuitry may, in some embodiments, be operated without battery power at low operational expense, with low maintenance costs, and long device lifetimes.

One particular example of application of a wireless energy transfer service is in ambient IoT applications. As 5G and other wireless network embodiments, such as 6G, expand to applications beyond enhanced mobile broadband (eMBB), such as ultra-reliable low latency communications (URLLC) and machine type communication (MTC), wireless networks may include enhanced functionality to support ambient IoT functions for applications in asset management, logistics, warehousing, manufacturing, and beyond. For example, in some ambient IoT embodiments, a base station, such as a gNB, may read and write information stored on ambient IoT devices and provide energy to ambient IoT devices. In some cases, reflectors may be used to extend the reach of base stations, allowing information-bearing signals for transmission to and reception from ambient IoT devices to be reflected to and from a base station.

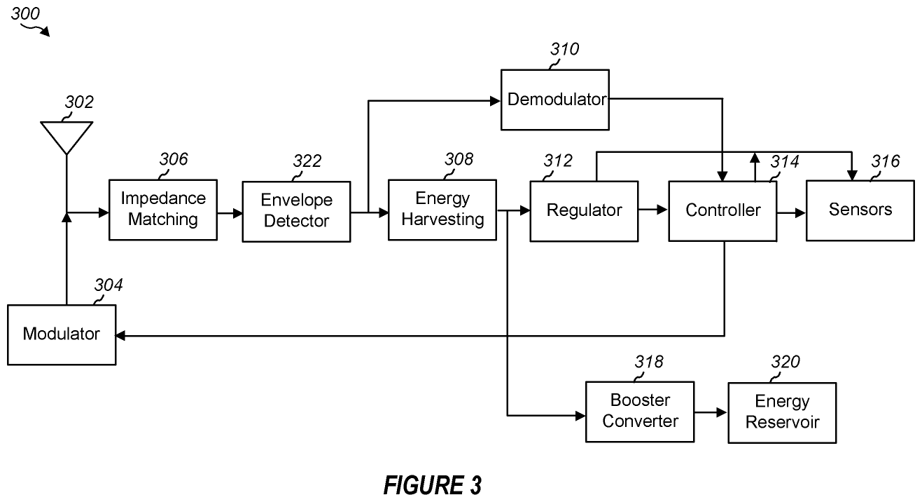

UEs may include energy harvesting circuitry, such as RFID energy harvesting circuitry or other energy harvesting circuitry, to harvest energy transmitted in wireless energy transmission signals. An example energy harvesting device 300 is shown in FIG. 3. The features shown in FIG. 3 may be integrated in a UE, such as a UE described with respect to FIGS. 1-2. In some embodiments, energy harvesting devices, such as UEs including RFID circuitry, may include small transponders, referred to as tags, that emit an information-bearing signal upon receiving a signal. Tags may be passive, harvesting energy over the air with no energy storage capacity, semi-passive, harvesting energy over the air with some energy storage capacity, or active, able to harvest energy over the air with substantial energy storage capacity. For example, active tags may include transceiver functionality with ability to engage in conventional signal transmission and reception activities and to operate in ultra-high-frequency ranges, such as 902-928 MHz, and microwave frequency ranges, such as 2400-2483.5 MHz and 5725-5850 MHz. Active tags may also include battery or capacitance energy storage to increase reliability of communication and sensitivity of the energy harvesting circuitry. In some cases, active tags may be connected to other external power sources. Semi-passive tags may include battery or capacitance energy storage but may include transponder functionality, rather than full transceiver functionality, and may communicate using backscatter channels at ultra-high frequency ranges, such as 902-928 MHz, and microwave frequency ranges, such as 2400-2483.5 MHz and 5725-5850 MHz. Semi-passive tags may also have inductive coupling capabilities for charging at high frequencies, such as 13.56 MHz and low frequencies, such as 125 or 134 kHz. Passive tags may not include energy storage capabilities and may otherwise include functionality similar to semi-passive tags. Furthermore, passive tags may include surface acoustic wave functionality at microwave frequencies, such as 2400-2483.5 MHz. One particular example implementation of passive tags is inclusion of such tags in ambient IoT devices. Ambient IoT devices may, for example, include passive or semi-passive tags.

An energy harvesting device 300, as shown in FIG. 3, may receive energy transmitted over a wireless network, such as a 5G or 6G wireless network, by a network entity, such as a base station. The energy harvesting device 300 may include an antenna 302 for receiving signals, such as energy transfer signals or signaling related to energy transfer. The energy harvesting device 300 may include an impedance matching module 306 for performing impedance matching based on received energy signals. The demodulator 310 may demodulate one or more signals received by the energy harvesting device 300. Envelope detector 322 may detect one or more sequences transmitted in a wake-up signal, such as amplitude shifting key sequences or Baker sequences, and may determine whether the one or more sequences correspond to the energy harvesting device 300. For example, the envelope detector may extract a sequence transmitted in a wake-up signal and may compare the sequence with one or more stored sequences associated with the energy harvesting device 300. The envelope detector 322 may be a passive envelope detector. In some embodiments, the envelope detector 322 may be a part of energy harvesting circuit 308. Energy harvesting circuit 308 may include one or more diodes or rectifiers for converting energy received via antenna 302 for use by the energy harvesting device 300. The regulator 312 may regulate received energy converted by the energy harvesting circuit 308 to provide a regulated voltage and current to power the controller 314. The regulated energy may be used to power controller 314, which may interpret demodulated signals received from the demodulator 310 and may control one or more sensors 316 and other components of the energy harvesting device 300. For example, the energy harvesting device 300 may be or may be included in a wireless sensing UE including one or more passive sensors 316. In some embodiments, the controller 314 may monitor a power at an input to or an output of the energy harvesting circuit 308 or a state of the energy harvesting circuit 308, such as a state of a rectifier of the energy harvesting circuit 308, when a wake-up signal from a base station is passed through the energy harvesting circuit 308, to detect an indication that the wake-up signal is addressed to the energy harvesting device 300. For example, such an indication may be included in a pattern of a power of the wake-up signal when passed through the energy harvesting circuit 300. In some embodiments, such an indication may be associated with one or more characteristics of the energy harvesting circuit 308, such as a power profile of the energy harvesting circuit 308.

The controller 314 may further control modulator 304 to modulate signals for transmission via antenna 302 to the energy transmitter, such as to a base station. Such signals may, for example, include sensor data from sensors 316. The signals transmitted by the antenna 302 may, for example, be backscatter modulated information signals. Energy output from the energy harvesting circuit 308 may further be stored by the energy harvesting device 300, if the energy harvesting device 300 is a semi-passive or active RF tag. For example, booster converter 318 may boost and convert a voltage output from energy harvesting circuit 308 for storage at energy reservoir 320. Energy reservoir 320 may, for example, include one or more capacitors, one or more batteries, or other energy storage components. The energy reservoir 320 may, when energy is stored, be used to power the controller 314, sensors 316, and other components of the energy harvesting device 300.

Power output by energy harvesting circuit 308 may, for example, be non-linear with power input to the energy harvesting circuit 308 due to diodes included in the energy harvesting circuitry. For example, input power to the energy harvesting circuit 308 may be larger than −20 dBM, such as −10 dBm, to activate the energy harvesting circuit 308, such as to overcome a sensitivity voltage of one or more diodes of the energy harvesting circuit 308. The energy harvesting circuit 308 may operate with greater efficiency at lower frequencies of power transmission and reception, due to diode junction capacitance and resistance of one or more diodes included in the energy harvesting circuit 308. For example, the energy harvesting circuit 308 may have a frequency-selective conversion efficiency.

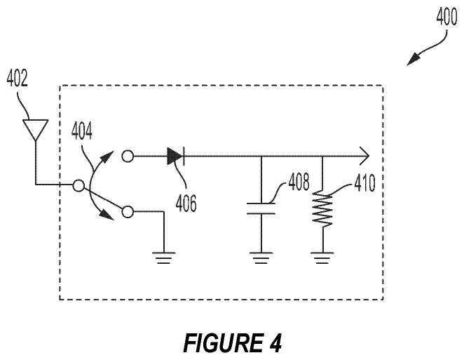

An example circuit diagram of an energy harvesting circuit 400 is shown in FIG. 4. The energy harvesting circuit 400 may be integrated in a UE and may receive an energy transmission signal from a network entity, such as a base station, The switch 404 may connect to ground when transmitting a signal and may connect to diode 406 when receiving an energy transmission signal. Diode 406 may, for example, be or be part of a rectifier of the energy harvesting circuit 400 and may rectify a received energy signal for provision to capacitive loads 408 and resistive loads 410, along with other loads. Thus, an energy harvesting circuit 400 may convert energy transmitted in an energy transmission signal for use by components of a device in which the energy harvesting circuit 400 is integrated. Rectifiers, such as diode 406, may have different power profiles, as discussed herein, depending on different physical characteristics of the rectifiers. One example of an indication of a UE to which a wake-up signal is addressed, that may be included in a wake-up signal, is a power at an input to or an output of an energy harvesting circuit 400 when the signal is passed through the energy harvesting circuit 400. For example, a power level at an input to the diode 406 or an output from the diode 406 may be used to determine whether a wake-up signal passed through the diode 406 is addressed to a UE including the energy harvesting circuit 400.

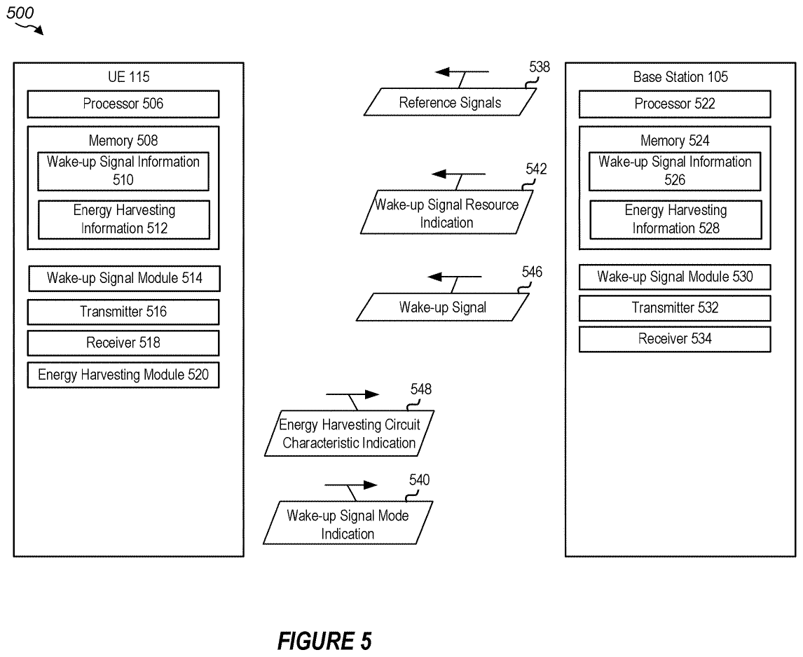

FIG. 5 is a block diagram of an example wireless communications system 500 that supports wake-up signal functionality for energy harvesting devices according to one or more aspects. In some examples, the wireless communications system 500 may implement aspects of the wireless network 100. The wireless communications system 500 includes the UE 115 and the base station 105. Although one UE 115 and one base station 105 are illustrated, in some other implementations, the wireless communications system 300 may generally include multiple UEs 115, and may include more than one base station 105.

The UE 115 can include a variety of components (such as structural, hardware components) used for carrying out one or more functions described herein. For example, these components can include one or more processors 506 (hereinafter referred to collectively as “the processor 506”), one or more memory devices 508 (hereinafter referred to collectively as “the memory 508”), one or more transmitters 516 (hereinafter referred to collectively as “the transmitter 516”), and one or more receivers 518 (hereinafter referred to collectively as “the receiver 518”). The processor 506 may be configured to execute instructions stored in the memory 508 to perform the operations described herein. In some implementations, the processor 506 includes or corresponds to one or more of the receive processor 258, the transmit processor 264, and the controller 280, and the memory 508 includes or corresponds to the memory 282. In some implementations, the processor 506 includes or corresponds to the controller 314.

The memory 508 includes or is configured to store wake-up signal information 510 and energy harvesting information 512. The wake-up signal information 510 may be information for performing a wake-up signal reception and pattern determination procedure as described herein. For example, the wake-up signal information 510 may include information indicating one or more wake-up signal modes supported by the UE 115, such as information indicating whether a UE supports reception of a wake-up signal including an indication of a UE to which the wake-up signal is addressed in a sequence of the wake-up signal or in a pattern of power levels of the wake-up signal. The wake-up signal information 510 may include an indication of a power saving mode configuration transmitted by base station 105. The wake-up signal information 510 may include an indication of one or more resources for measuring one or more reference signals transmitted by the base station 105. The wake-up signal information 510 may include one or more measurements of one or more reference signals transmitted by the base station 105, an indication of a wake-up signal mode selected based on one or more measurements of one or more reference signals, an indication of one or more resources for monitoring for a wake-up signal, an indication of one or more resources to monitor for reception of information from the base station 105 upon receipt of a wake-up signal addressed to the UE 115. In some embodiments, the wake-up signal information 510 may include one or more sequences, such as amplitude shifting key sequences or Baker sequences, or one or more patterns of power levels of a wake-up signal associated with the UE 115. The energy harvesting information 512 may include one or more characteristics of an energy harvesting module 520 of the UE 115, such as one or more characteristics of an energy harvesting circuit. For example, the one or more characteristics of the energy harvesting circuit may include one or more characteristics of a rectifier of an energy harvesting circuit. In particular, the one or more characteristics of the energy harvesting circuit may include a power profile of the energy harvesting circuit, a saturation threshold of the energy harvesting circuit, a sensitivity threshold of the energy harvesting circuit, or other characteristics of an energy harvesting circuit.

The transmitter 516 is configured to transmit reference signals, control information and data to one or more other devices, and the receiver 518 is configured to receive references signals, synchronization signals, control information and data from one or more other devices. For example, the transmitter 516 may transmit signaling, control information and data to, and the receiver 518 may receive signaling, control information and data from, the base station 105. In some implementations, the transmitter 516 and the receiver 518 may be integrated in one or more transceivers. Additionally or alternatively, the transmitter 516 or the receiver 518 may include or correspond to one or more components of the UE 115 described with reference to FIG. 2.

The UE 115 may further include a wake-up signal module 514. The wake-up signal module 514 may include instructions or logic to cause the UE 115 to perform the operations described herein, such as to measure reference signals, select a wake-up signal mode based on measured reference signals, to determine and transmit an indication of energy harvesting circuit characteristics, to monitor for and receive a wake-up signal, to determine if an indication of a UE to which the wake-up signal is addressed corresponds to the UE 115, and to monitor one or more resources for transmission of information by the base station 105 when a wake-up signal addressed to the UE 115 is received.

The UE 115 may include an energy harvesting module 520 for harvesting energy transmitted in wireless energy transmission signals over a wireless network. The energy harvesting module 520 may correspond to one or more components of the energy harvesting device 300 or the energy harvesting circuit 400. In some embodiments, the energy harvesting module 520 may be configured to monitor a power at an input to an energy harvesting circuit, a power at an output of an energy harvesting circuit, a zone of operation of an energy harvesting circuit, or other properties of an energy harvesting circuit when a wake-up signal is passed through the energy harvesting circuit. The energy harvesting module 520 may communicate with the wake-up signal module 520 to determine if a pattern of the power of the wake-up signal corresponds to the UE 115. In some embodiments, the energy harvesting module 520 may include a passive envelope detector for determining, in cooperation with the wake-up signal module 514, whether a sequence transmitted in a wake-up signal corresponds to the UE 115.

The base station 105 can include a variety of components (such as structural, hardware components) used for carrying out one or more functions described herein. For example, these components can include one or more processors 522 (hereinafter referred to collectively as “the processor 522”), one or more memory devices 524 (hereinafter referred to collectively as “the memory 524”), one or more transmitters 532 (hereinafter referred to collectively as “the transmitter 532”), and one or more receivers 534 (hereinafter referred to collectively as “the receiver 534”). The processor 522 may be configured to execute instructions stored in the memory 524 to perform the operations described herein. In some implementations, the processor 522 includes or corresponds to one or more of the receive processor 238, the transmit processor 220, and the controller 240, and the memory 524 includes or corresponds to the memory 242.

The memory 524 includes or is configured to store wake-up signal information 526 and energy harvesting information 528. The wake-up signal information 526 may be information for performing a wake-up signal reception and pattern determination procedure as described herein. For example, the wake-up signal information 526 may include information indicating one or more wake-up signal modes supported by the UE 115, such as information indicating whether a UE supports reception of a wake-up signal including an indication of a UE to which the wake-up signal is addressed in a sequence of the wake-up signal or in a pattern of power levels of the wake-up signal. The wake-up signal information 526 may include an indication of a power saving mode configuration for transmission from the base station 105 to the UE 115. The wake-up signal information 526 may include an indication of one or more resources for transmission one or more reference signals for measurement by the UE 115. The wake-up signal information 526 may include one or more measurements of one or more reference signals transmitted by the base station 105 by the UE 115. For example, such measurements may be transmitted by the UE 115 to base station 105. The wake-up signal information 526 may include an indication of a wake-up signal mode for the UE 115 selected by UE 115 based on one or more measurements of one or more reference signals, an indication of one or more resources for transmission of a wake-up signal, an indication of one or more resources for transmission of information to the UE 115 upon receipt of a wake-up signal addressed to the UE 115. In some embodiments, the wake-up signal information 526 may include one or more sequences, such as amplitude shifting key sequences or Baker sequences, or one or more patterns of power levels of a wake-up signal associated with the UE 115 or other UEs for inclusion in one or more wake-up signals. In some embodiments, the sequences or power level patterns may be associated with groups of UEs for transmission in a wake-up signal to wake a group of UEs. The energy harvesting information 528 may include one or more characteristics of an energy harvesting module 520 of the UE 115, or of other UEs, such as one or more characteristics of an energy harvesting circuit. For example, the one or more characteristics of the energy harvesting circuit may include one or more characteristics of a rectifier of an energy harvesting circuit. In particular, the one or more characteristics of the energy harvesting circuit may include a power profile of the energy harvesting circuit, a saturation threshold of the energy harvesting circuit, a sensitivity threshold of the energy harvesting circuit, or other characteristics of an energy harvesting circuit.

The transmitter 532 is configured to transmit reference signals, synchronization signals, control information and data to one or more other devices, and the receiver 534 is configured to receive reference signals, control information and data from one or more other devices. For example, the transmitter 532 may transmit signaling, control information and data to, and the receiver 534 may receive signaling, control information and data from, the UE 115. In some implementations, the transmitter 532 and the receiver 534 may be integrated in one or more transceivers. Additionally or alternatively, the transmitter 532 or the receiver 534 may include or correspond to one or more components of base station 105 described with reference to FIG. 2.

The base station 105 may further include a wake-up signal module 530. The wake-up signal module 530 may include instructions or logic to cause the base station 105 to perform the operations described herein, such as to transmit reference signals, receive an indication of a wake-up signal mode based on measured reference signals, to receive an indication of energy harvesting circuit characteristics of a UE, to transmit a wake-up signal including an indication of a UE to which the wake-up signal is addressed, and to transmit information on one or more resources after transmitting a wake-up signal.

In some implementations, the wireless communications system 500 implements a 5G New Radio (NR) network, a 6G network, or another network. For example, the wireless communications system 500 may include multiple 5G-capable UEs 115 and multiple 5G-capable base stations 105, such as UEs and base stations configured to operate in accordance with a 5G NR network protocol such as that defined by the 3GPP.

During operation of the wireless communications system 500, the base station 105 may transmit one or more reference signals 538. Such reference signals may, for example, be one or more reference signals for measurement by the UE 115 to determine a wake-up signal mode of the UE 115. In some embodiments, the base station 105 may transmit a power saving mode configuration to the UE 115 to configure a power saving mode of the UE 115. In some embodiments, the base station 105 may transmit a reference signal configuration to UE 115, such as an indication of one or more resources for the UE 115 to monitor for the reference signals 538. The UE 115 may perform one or more measurements on the reference signals 538. In some embodiments, the UE 115 may determine a wake-up signal mode of the UE 115 based on measurements of the reference signals 538.

The UE 115 may transmit a wake-up signal mode indication 540 to the base station 105. The wake-up signal mode indication 540 may indicate a wake-up signal mode for the UE 115, such as a wake-up signal mode determined by the UE 115 based on measurement of the reference signals 538. In some embodiments, the wake-up signal mode indication 540 may include an indication of one or more measurements of the reference signals 538. In some embodiments, the wake-up signal mode indication 540 may include an indication of whether one or more wake-up signals transmitted to the UE 115 should include an indication that the wake-up signals are addressed to the UE 115 in the form of a sequence associated with the UE 115 or a pattern of power levels associated with the UE 115.

The base station 105 may transmit a wake-up signal resource indication 542 to the UE 115 indicating one or more resources the UE 115 should monitor for transmission of a wake-up signal 546 by the base station 105. The UE 115 may receive the wake-up signal resource indication 542 and may monitor one or more resources indicated by the wake-up signal resource indication 542 for transmission of a wake-up signal 546.

The base station 105 may transmit a wake-up signal 546 to the UE 115 to instruct the UE 115 to monitor one or more resources for transmission of information by the base station 105. The wake-up signal 546 may include an indication that the wake-up signal 546 is addressed to the UE 115. For example, the wake-up signal 546 may include a sequence, such as an amplitude shifting key sequence or a Baker sequence, associated with the UE 115 or a pattern of power levels of the wake-up signal 546 associated with the UE 115. The UE 115 may receive the wake-up signal 546 and may monitor one or more resources, such as one or more time or frequency resources based on receipt of the wake-up signal. For example, the UE 115 may receive the wake-up signal 546 and may determine that the wake-up signal includes an indication that the wake-up signal is addressed to the UE. Based on such a determination, the UE 115 may monitor one or more resources for transmission of information from the base station 105. For example, the UE 115 may exit a low power mode when such a wake-up signal 546 is received. If the wake-up signal 546 does not include an indication that the wake-up signal is addressed to the UE 115, the UE 115 may refrain from monitoring the one or more resources for transmission of information from the base station 105. For example, the UE 115 may remain in a low power mode when a received wake-up signal 546 does not include an indication that the wake-up signal is addressed to the UE 115. Thus, a UE 115 with energy harvesting functionality and a base station 105 may communicate to facilitate wake-up signal functionality of the UE 115.

As described with reference to FIG. 3, the present disclosure provides techniques for wake-up signal functionality in UEs with energy harvesting functionality. Use of a wake-up signal may reduce monitoring overhead of such UEs, reducing a power consumption of such UEs. The reduced power consumption may allow for design of UEs with energy harvesting functionality having less onboard power storage capacity. A reduction in onboard power storage capacity may allow for reductions in cost and form factors of UEs.

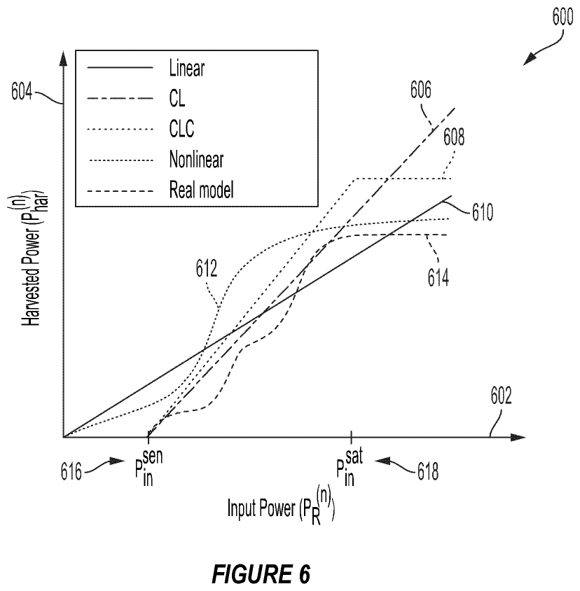

Energy harvesting circuits and, in particular, rectifiers of energy harvesting circuits may have different power profiles based on physical characteristics of the energy harvesting circuits. For example, energy harvesting circuits may have different relationships between input power and output power and different power harvesting efficiencies. An example graph 600 of input power on the x-axis 602 and output power or harvested power on the y-axis 604 for a plurality of energy harvesting circuits is shown in FIG. 6. As one example, in a first power profile 610 power output from an energy harvesting circuit may be a continuous, linear, increasing function of input radio frequency (RF) power. As another example, in a second power profile 612 a relationship between power output from the energy harvesting circuit and input power to the energy harvesting circuit may be continuous, nonlinear, and increasing. Some energy harvesting circuits may operate with sensitivity power thresholds, such as sensitivity power threshold 616. When power input to the energy harvesting circuit is below the sensitivity power threshold 616, the energy harvesting circuit may operate in a sensitivity zone, and power output from the energy harvesting circuit may be minimal or zero. As one example, in a third power profile 606 power output from an energy harvesting circuit when an input power is below the sensitivity power threshold may be near or at zero, while a relationship between power output from the energy harvesting circuit and input power to the energy harvesting circuit greater than the sensitivity threshold may be continuous, linear, and increasing. Some energy harvesting circuits may operate with a saturation power threshold, such as saturation power threshold 618. When power input to the energy harvesting circuit exceeds the saturation power threshold, the energy harvesting circuit may operate in a saturation zone, and power output from the energy harvesting circuit may remain constant or increase minimally, even as the input power continues to increase. Some energy harvesting circuits may operate with both sensitivity thresholds and saturation thresholds, and a zone of operation when a power input to the energy harvesting circuit is between the sensitivity threshold and the saturation threshold may be referred to as the required zone. As one example, in a fourth power profile 608, a power output from an energy harvesting circuit when an input power is below a sensitivity threshold 616 may be minimal or zero, a relationship between an output power of the energy harvesting circuit and an input power when the input power is above the sensitivity threshold 616 but below the saturation threshold 618 may be continuous, linear, and increasing, and a power output from the energy harvesting circuit may remain constant or increase minimally when the input power exceeds the saturation threshold 618. As another example, a fifth power profile 614 may be similar to the fourth power profile 608, except between the sensitivity threshold 616 and the saturation threshold 618 a relationship between the input power and the output power may be continuous, nonlinear, and increasing. Thus, energy harvesting circuits and rectifiers of energy harvesting circuits, which may be included in UEs having energy harvesting functionality may have different power profiles based on the characteristics of the energy harvesting circuits. For example, different energy harvesting circuits may have different sensitivity thresholds, saturation thresholds, relationships between input power and output power, and power profiles in general.

In some embodiments, a wake-up signal for a UE with energy harvesting functionality may include a sequence indicating a UE or group of UEs to which the wake-up signal is addressed. For example, a wake-up signal may carry a sequence, such as a amplitude shifting key sequence or Baker sequence, that is associated with a UE. A UE receiving such a wake-up signal may detect the sequence included in the wake-up signal, may compare the sequence with a stored sequence associated with the UE, and, if the sequence corresponds to the stored sequence associated with the UE, may begin to monitor one or more resources for transmission of information by the base station. In some embodiments, the wake-up signal may be passed through a passive envelope detector of the UE, such as a passive envelope detector of an energy harvesting circuit of the UE, to determine if a sequence of the signal is associated with the UE. For example, such a sequence may include on/off keying only for the UE. A passive envelope detector may, for example, be low complexity and low cost, allowing for production of UEs with reduced form factors and cost. In some embodiments, different wake-up signals may include different indications associated with different UEs. For example, resources on which wake-up signals are transmitted to UEs with energy harvesting functionality may be orthogonalized such that different resources are used for transmission of wake-up signals to different UEs. Such wake-up signal transmission may, however, be inefficient, as resources may be required to remain unused when a wake-up signal is not being transmitted to a UE or to a particular group of UEs. In some embodiments, different scrambling of a sequence or a different sequence may be used for indication that a wake-up signal is addressed to different UEs. Use of a sequence in a wake-up signal to indicate a UE or group of UEs to which the wake-up signal is addressed may, however, encounter false alarms and/or missed detection.

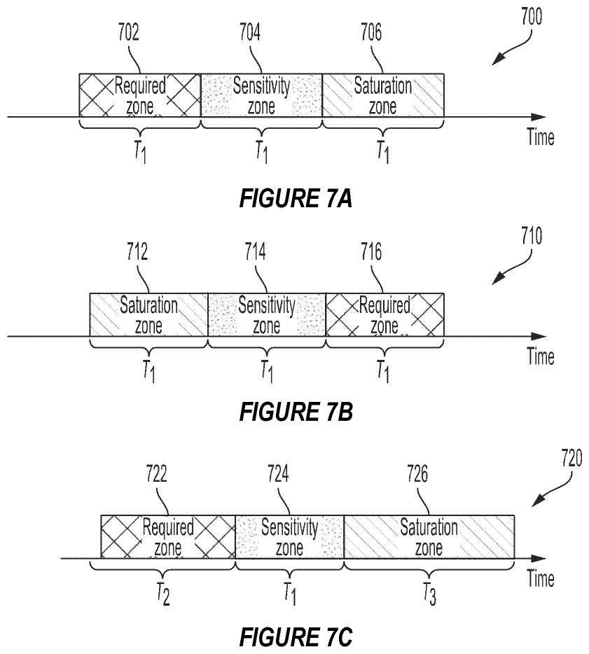

As another example, an indication that a wake-up signal is addressed to a particular UE or group of UEs may include a pattern of a power of the wake-up signal, such as a pattern of a power level of the wake-up signal. As one particular example, a pattern of a power of the wake-up signal may be configured to vary an operating zone of an energy harvesting circuit of a UE, such as an operating zone of a rectifier of the energy harvesting circuit of the UE, in a particular pattern associated with the UE. If the UE detects variation of the operating zone of the energy harvesting circuit of the UE that matches a pattern associated with the UE when the wake-up signal is passed through the energy harvesting circuit, the UE may determine that the wake-up signal is addressed to the UE. A first pattern 700 is shown in FIG. 7A. In first pattern 700, at a first time 702 the energy harvesting circuit may operate in a required zone, at a second time 704 following the first time the energy harvesting circuit may operate in a sensitivity zone, and at a third time 706 following the second time the energy harvesting circuit may operate in a saturation zone. Thus, the first pattern 700 may comprise an indication that a wake-up signal is addressed to a first UE or group of UEs associated with the first pattern 700. In a second patten 710 of FIG. 7B, an energy harvesting circuit may operate in a saturation zone at a first time 712, in a sensitivity zone at a second time 714, and in a required zone at a third time 716. Thus, the second pattern 710 may comprise an indication that a wake-up signal is addressed to a second UE or group of UEs associated with the second pattern 710. In some embodiments, a time for which the energy harvesting circuit of the UE is in a particular operating zone may also be part of the indication of the wake-up signal. For example, in a third pattern 720 of FIG. 7C, an energy harvesting circuit of a UE may operate in a required zone for a first time 722, a sensitivity zone for a second time 724, and a saturation zone for a third time 726. The first time 722, the second time 724, and the third time 726 may all have different time lengths. The third pattern 720 may comprise an indication that a wake-up signal is addressed to a third UE or group of UEs. In some embodiments, different lengths of times 722, 724 and 726 may indicate that wake-up signals are addressed to different UEs. For example, a pattern similar to the pattern of 720, with a time period of operation in a saturation zone that is shorter or longer than time period 726 may correspond to a different UE. As one particular example, the pattern 720 may be similar to the pattern 700, except a time period 726 may be longer in duration than a time period 706. The difference between time period 706 and time period 726 may cause pattern 700 to correspond to a first UE and pattern 720 to correspond to a third, different, UE. In some embodiments, different power harvesting circuits may have different power profiles, such as different saturation thresholds or sensitivity thresholds as discussed herein, and a power of a wake-up signal may be configured to produce a pattern associated with a UE to which the wake-up signal is addressed based on the characteristics of the energy harvesting circuit of the UE. In some embodiments, a pattern, as discussed with respect to FIGS. 7A-C may not begin or end with operation in a sensitivity zone. In some embodiments a pattern associated with a particular UE or group of UEs may be predefined or configured by radio resource control (RRC). Thus, a pattern of a power of a wake-up signal may indicate a UE to which the wake-up signal is addressed by causing an energy harvesting circuit of the UE to operate in particular zones for particular time periods having a same or different duration.

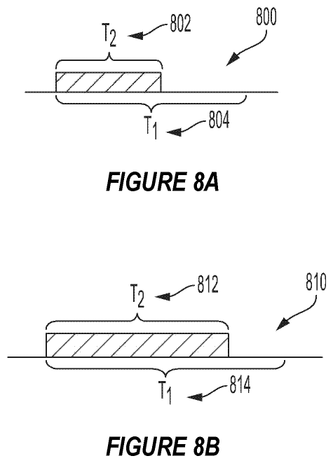

As another example, a pattern of a power of a wake-up signal may include a power of the wake-up signal exceeding a first power threshold for a period of time of a particular length. The power of the wake-up signal may be measured by a UE to determine if the power exceeds the first threshold at an input to or an output from an energy harvesting circuit of the UE. In some embodiments, such a threshold may be a threshold for changing an operating zone of an energy harvesting circuit of the UE, such as a sensitivity threshold or a saturation threshold. In some embodiments, the threshold may be greater than a sensitivity threshold. In some embodiments, the threshold may be between a sensitivity threshold and a saturation threshold. For example, in the first pattern 800 of FIG. 8A, a power level of a wake-up signal may exceed a threshold for a first portion 802 of a first time period. The first pattern 800 may indicate that the wake-up signal is addressed to a first UE or group of UEs. As another example, in the second pattern 810 of FIG. 8B, a power level of a wake-up signal may exceed the threshold for a first portion 812 of a second window 814. The second pattern 810 may indicate that the wake-up signal is addressed to a second UE or group of UEs. The first window 804 and the second window 814 may be of a same length. Thus, the first portion 812 of the second window 814 may exceed the first portion 802 of the first window 804 in length. If a same power threshold is used for the first pattern 800 and the second pattern 810, receipt of the second pattern 810 may also wake a UE associated with the first pattern 800. In some embodiments, different power thresholds may be used for different devices. In some embodiments, a window and a portion of a window, as discussed with respect to FIGS. 8A-B may be predefined or configured via RRC.

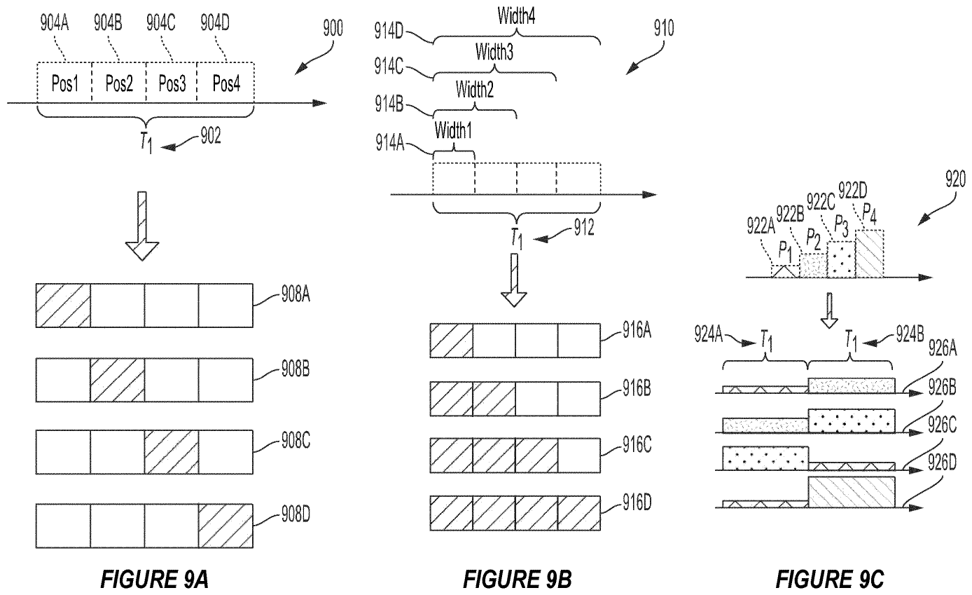

As another example, a pattern of a power of a wake-up signal may include a power of a wake-up signal exceeding a threshold at a particular time. For example, as shown in the example pattern layout 900 of FIG. 9A, a monitoring window 902 may be divided into four sub-windows 904A-D. In some embodiments, a monitoring window may be divided into more or fewer than four sub-windows. A UE to which a wake-up signal is addressed may be indicated by a power of the wake-up signal, such as a power of a wake-up signal at an input to or an output of an energy harvesting circuit, exceeding a threshold power at a particular window. Each sub-window 904A-D may correspond to a particular UE or group of UEs. For example, in a first pattern 908A corresponding to a first UE or group of UEs, a power of a wake-up signal may exceed a threshold at a first sub-window 904A. In a second pattern 908B corresponding to a second UE or group of UEs, a power of a wake-up signal may exceed a threshold at a second sub-window 904B. In a third pattern 908C corresponding to a third UE or group of UEs, a power of a wake-up signal may exceed a threshold at a third sub-window 904C. In a fourth pattern 908D corresponding to a fourth UE or group of UEs, a power of a wake-up signal may exceed a threshold at a fourth sub-window 904D. A number of bits indicated by the window 902 may depend on a number of sub-windows into which the window 902 is divided. For example, every two sub-windows may represent one bit of information.

As another example, a pattern of a power of a wake-up signal may include a power of a wake-up signal exceeding a threshold for a particular number of sub-windows. For example, as shown in the example pattern layout 910 of FIG. 9B, a monitoring window 912 may be configurable with four different lengths 914A-D of sub-windows. In some embodiments, a monitoring window may be divided into more or fewer than four different lengths of sub-windows. A UE to which a wake-up signal is addressed may be indicated by a power of the wake-up signal, such as a power of a wake-up signal at an input to or an output of an energy harvesting circuit, exceeding a threshold power for a particular number of sub-windows. Each length of sub-windows 914A-D may correspond to a particular UE or group of UEs. For example, in a first pattern 916A corresponding to a first UE or group of UEs, a power of a wake-up signal may exceed a threshold for a first length 914A of sub-windows. In a second pattern 916B corresponding to a second UE or group of UEs, a power of a wake-up signal may exceed a threshold for a second length 914B of sub-windows. In a third pattern 916C corresponding to a third UE or group of UEs, a power of a wake-up signal may exceed a threshold for a fourth length 916C of sub-windows. In a fourth pattern 916D corresponding to a fourth UE or group of UEs, a power of a wake-up signal may exceed a threshold for a fourth length 914D of sub-windows. A number of bits indicated by the window 912 may depend on a number of lengths of sub-windows into which the window 912 is divided. For example, every two lengths of sub-windows may correspond to one bit of information.

As another example, a pattern of a power of a wake-up signal may include a power level of a wake-up signal at a plurality of different time windows. For example, a power level of a wake-up signal at an input to or an output from an energy harvesting circuit at a plurality of time periods may indicate a UE to which a wake-up signal is addressed. For example, a wake-up signal may include one or more of the plurality of power levels 922A-D shown in the example pattern layout 920 of FIG. 9C. In some embodiments, the power levels of FIG. 9C, and other power levels as discussed herein, may correspond to power ranges, where the power is below a first threshold and above a second threshold for each power level. For example, a UE may monitor for a wake-up signal in a plurality of time windows, such as a first time window 924A and a second time window 924B. A power level of the wake-up signal in the first time window 924A and the second time window 924B may be a pattern of the power level indicating that the wake-up signal is addressed to a particular UE. For example, a first pattern 926A associated with a first UE or group of UEs may include a power at a first level 922A in the first time window 924A and a second power level 922B in the second time window 924B. A second pattern 926B associated with a second UE or group of UEs may include a power at a second level 922B in the first time window 924A and a third power level 922C in the second time window 924B. A third pattern 926C associated with a third UE or group of UEs may include a power at a third level 922C in the first time window 924A and a first power level 922A in the second time window 924B. A fourth pattern 926D associated with a fourth UE or group of UEs may include a power at a first level 922A in the first time window 924A and a fourth power level 922D in the second time window 924B. In some embodiments, fewer or more than two time windows may be used and fewer or more than four power levels may be used. A number of bits of information indicated by such a pattern may be based on number of time windows and power levels used. For example, if four power levels and two windows are used, each power level may indicate two bits of information. Thus, a pattern of a power level indicating a UE to which a wake-up signal is addressed may include a plurality of power levels in a plurality of time windows. In some embodiments, the features of the patterns of FIGS. 9A, 9B, and 9C may be combined to indicate UEs to which a wake-up signal is addressed. For example, particular power levels in particular sub-windows of a monitoring window may indicate particular UEs.

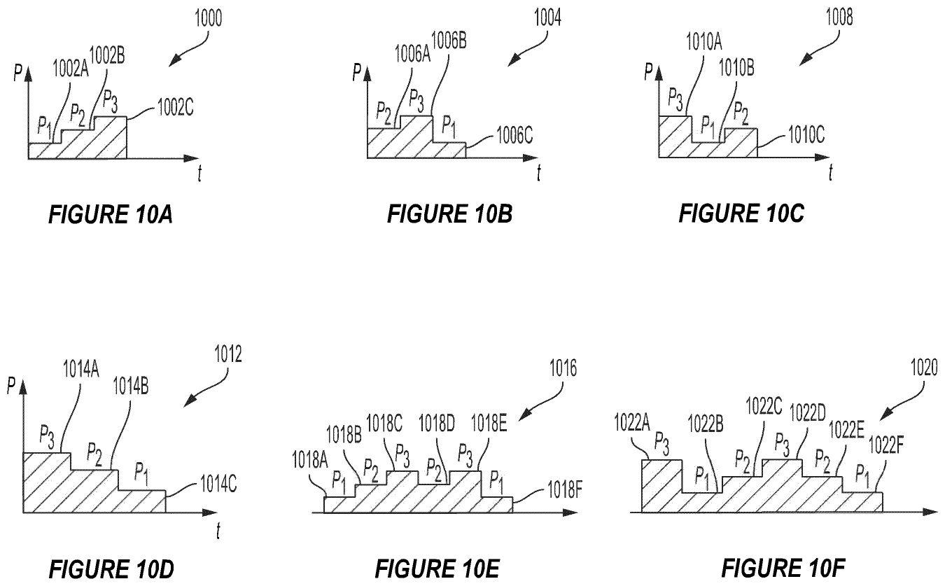

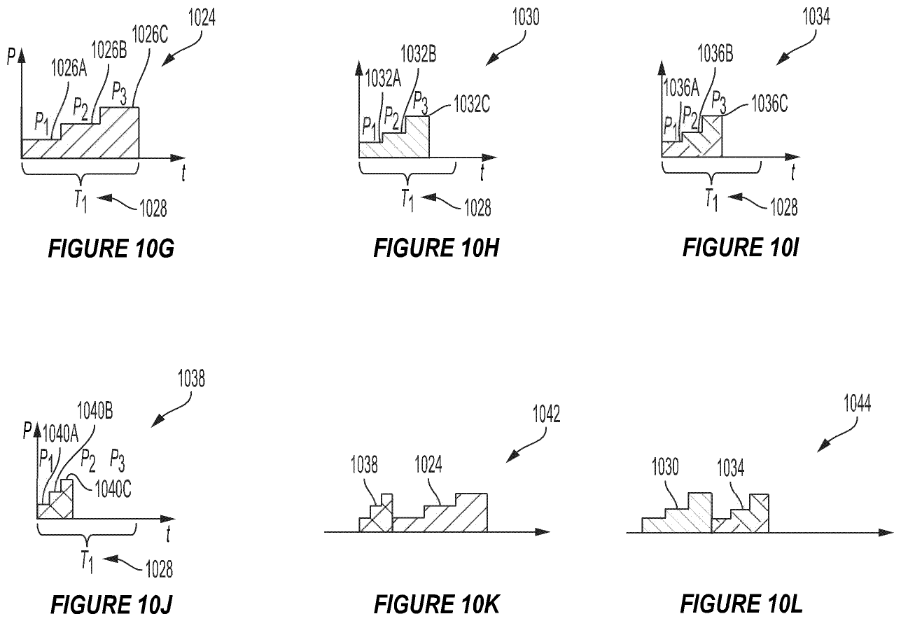

As another example, different patterns of increases and decreases of power levels or different slopes of increases and decreases of power levels of a wake-up signal may indicate different UEs to which a wake-up signal is addressed. Such patterns may be referred to as chirp-like power signals. In some embodiments, different patterns of increases and decreases of a power level may indicate different binary information which may correspond to different UEs. For example, an increase in a power level may correspond to a 1, while a decrease in a power level may correspond to a 0. As another example, to allow a pattern of a power level to carry more information, a cyclic rotation of N power levels may be used with an N! pattern, where an information bit will be equal to [log(2N!)]. As one particular example, a power level of a wake-up signal at an input to or an output from an energy harvesting circuit of a UE may increase or decrease over time with a fixed value, delta P. For example a current power may be equal to a previous power plus or minus a fixed increment, such as a constant k multiplied by a change in power and a change in time. The values of the change in power and the change in time may be predefined, may be configured via RRC, or may be indicated dynamically. In some embodiments, different UEs may be configured with different delta P values to allow for further variations of wake-up signals corresponding to additional UEs. In some embodiments, power may be divided into different levels and a power level may increase or decrease with time. Power levels, such as those discussed with respect to FIGS. 10A-M may be uniformly quantized or non-uniformly quantized depending on characteristics of an energy harvesting circuit, such as rectifier characteristics of an energy harvesting circuits. In some embodiments, such power levels may be predefined, configured via RRC, or reported by a UE to a base station. As another example, different UEs may be configured with different divisions of power to monitor for in wake-up signals to allow for further variations of power levels indicating that wake-up signals are addressed to additional UEs. As one example, a first pattern 1000 of FIG. 10A may include an increase from a first power level 1002A to a second power level 1002B and an increase from the second power level 1002B to a third power level 1002C. The first pattern 1000 may represent a binary pair of 11, which may correspond to a first UE or set of UEs. As another example, a second pattern 1004 of FIG. 10B may include an increase from a second power level 1006A to a third power level 1006B and a decrease from the third power level 1006B to a first power level 1006C. The second pattern 1004 may represent a binary pair of 10, which may correspond to a second UE or set of UEs. As another example, a third pattern 1008 of FIG. 10C may include a decrease from a third power level 1010A to a first power level 1010B and an increase from the first power level 1010B to a second power level 1010C. The third pattern 1008 may represent a binary pair of 01, which may correspond to a third UE or set of UEs. As another example, a fourth pattern 1012 of FIG. 10D may include a decrease from a third power level 1014A to a second power level 1014B and a decrease from the second power level 1014B to the third power level 1014C. The fourth pattern 1012 may represent a binary pair of 00, which may correspond to a fourth UE or set of UEs. In some embodiments patterns of power levels, such as those of FIGS. 10A-D may be combined to indicate more information. For example, in FIG. 10E the pattern of power levels 1018A-C of FIG. 10A may be combined with the pattern of power levels 1018D-F of FIG. 10B to generate a pattern 1016 indicating a binary string of 1110. The pattern 1016 may correspond to a first UE. Likewise, in FIG. 10F, the pattern of power levels 1022A-C of FIG. 10C may be combined with the pattern of power levels 1022D-F of FIG. 10D to generate a pattern 1020 indicating a binary string of 0100. The pattern 1020 may correspond to a second UE or set of UEs.

As another example, a pattern of power levels indicating a UE or group of UEs may include a plurality of slopes of power levels during a monitoring window. For example, a first slope may represent a binary 1 while a second slope may represent a binary 0. As one particular example, different slopes of a power level from a first power level to a third power level may correspond to different binary values, such as binary pairs. For example, a first pattern 1024 of FIG. 10G may include a first slope from a first power level 1026A to a second power level 1026B to a third power level 1026C. Thus, the first pattern 1024 and the first slope may correspond to a binary value of 11, which may correspond to a first UE. As another example, a second pattern 1030 of FIG. 10H may include a second slope from a first power level 1032A to a second power level 1032B to a third power level 1032C. Thus, the second pattern 1030 and the second slope may correspond to a binary value of 10, which may correspond to a second UE. As another example, a third pattern 1034 of FIG. 10I may include a third slope from a first power level 1036A to a second power level 1036B to a third power level 1036C. Thus, the third pattern 1034 and the third slope may correspond to a binary value of 01, which may correspond to a third UE. As another example, a fourth pattern 1038 of FIG. 10J may include a fourth slope from a first power level 1040A to a second power level 1040B to a third power level 1040C. Thus, the fourth pattern 1038 and the fourth slope may correspond to a binary value of 00, which may correspond to a fourth UE. In some embodiments, patterns, such as patterns 1024, 1030, 1035, and 1038 of FIGS. 10G-10J which may include particular slopes of power levels, may be combined to indicate more information, such as to provide more corresponding binary values for indication of UEs to which wake-up signals are addressed. For example, a fifth pattern 1042 of FIG. 10K may include the fourth pattern 1038 and the first pattern 1024 in sequence, which may represent a binary value of 0011. The fifth pattern 1042 may correspond to a one or more UEs. As another example, a sixth pattern 1044 of FIG. 10L may include the second pattern 1030 and the third pattern 1034 in sequence, which may represent a binary value of 1001. The fifth pattern 1044 may correspond to a one or more UEs. In some embodiments, patterns of power signals used to indicate a UE to which a wake-up signal is addressed may include both slopes of power levels, as discussed with respect to FIGS. 10G-L and increases or decreases of power levels, as discussed with respect to FIGS. 10A-F. For example, different combinations of slopes of power levels and increases or decreases of power levels of a wake-up signal may correspond to different UEs. Thus, different patterns of power levels at an input to or an output from an energy harvesting circuit of a UE when a wake-up signal is passed through the energy harvesting circuit may correspond to different UEs.

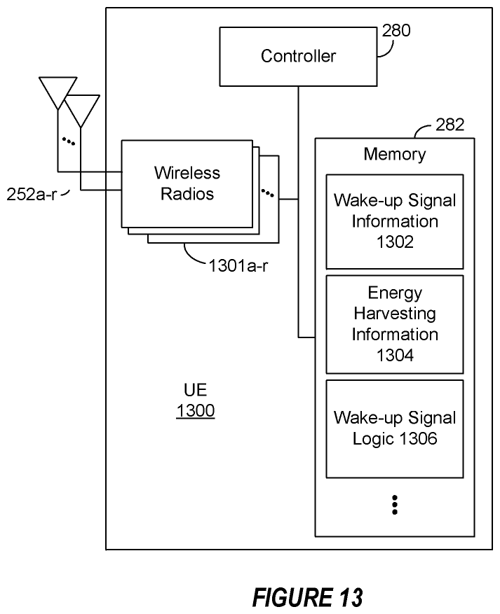

FIG. 11A is a flow diagram illustrating an example process 1100 that supports wake-up signal functionality in energy harvesting UEs according to one or more aspects. Operations of the process 1100 may be performed by a UE, such as the UE 115 described above with reference to FIGS. 1-2 and 5 or a UE as described with reference to FIG. 13. For example, example operations (also referred to as “blocks”) of the process 1100 may enable the UE 115 to receive a wake-up signal addressed to the UE and monitor one or more resources for transmissions from a base station in response to receipt of the wake-up signal.

In block 1102, a UE 115 may receive a wake-up signal including an indication that the wake-up signal is addressed to the UE 115. The indication may, for example, include a sequence associated with the UE 115, as discussed herein, or a pattern of power levels, as discussed herein. For example, the sequence may be an amplitude shifting key or Baker sequence that a passive envelope detector of the UE 115 is configured to detect, as discussed herein. The pattern of power levels may, for example, include a pattern of an operating zone of a rectifier of an energy harvesting circuit of the UE that is associated with the UE 115, as discussed with respect to FIGS. 7A-C, a power of a wake-up signal exceeding a first power threshold at a first time period, as discussed with respect to FIGS. 8A-B and 9A, a power of a wake-up signal exceeding a second power threshold for a first length of time, as discussed with respect to FIGS. 8A-B and 9B, a power of the wake-up signal being within a first range at a second time period and within a second range at a third time period, as discussed with respect to FIG. 9C, or a power of the wake-up signal crossing a first threshold at a first time and a second threshold at a second time, as discussed with respect to FIGS. 10A-L. The second threshold may, for example, be different from the first threshold. The UE 115 may determine that a sequence or pattern of power levels of a wake-up signal corresponds to the UE 115 by comparing a sequence or pattern of power levels of the wake-up signal with a sequence or pattern of power levels associated with the UE 115.

In block 1104, the UE 115 may monitor one or more resources in response to the indication that the wake-up signal is addressed to the UE 115. For example, if the wake-up signal includes an indication that the wake-up signal is addressed to the UE 115, the UE 115 may exit a low power mode and may monitor one or more resources for transmission of information from the base station. If the wake-up signal does not include an indication that the wake-up signal is addressed to the UE 115, such as if the wake-up signal includes an indication that the wake-up signal is addressed to a different UE, the UE 115 may refrain from monitoring one or more resources. For example, the UE may remain in a low power mode. In some embodiments, in response to receipt of a wake-up signal including an indication that the wake-up signal is addressed to the UE 115, the UE 115 may wake for a single wake window, such as a period of time, for monitoring the one or more resources for transmission from a base station.

FIG. 11B is a flow diagram illustrating an example process 1110 that supports wake-up signal functionality in energy harvesting UEs according to one or more aspects. Operations of the process 1110 may be performed by a UE, such as the UE 115 described above with reference to FIGS. 1-2 and 5 or a UE as described with reference to FIG. 13. For example, example operations (also referred to as “blocks”) of the process 1110 may enable the UE 115 to receive a wake-up signal addressed to the UE and monitor one or more resources for transmissions from a base station in response to receipt of the wake-up signal. In some embodiments, operations of the process 1110 may be performed along with operations of the process 1100 by a UE 115. For example, the operations of blocks 1112-1120 of FIG. 11B may be performed prior to the operations of blocks 1102-1104 of FIG. 11A, and the operations of block 1122 of FIG. 11B may be performed between the operations of block 1102 and block 1104 of FIG. 11A.

In block 1112, the UE 115 may receive one or more reference signals. For example, the UE 115 may receive one or more reference signals transmitted by a network entity, such as a base station. In some embodiments, receiving the one or more reference signals may include measuring the one or more reference signals.

In block 1114, the UE 115 may transmit an indication of a wake-up signal mode associated with measurements of the one or more reference signals. For example, the UE 115 may determine a wake-up signal mode based on one or more measurements of the one or more reference signals. In some embodiments, the indication of the wake-up signal mode may include an indication that the UE 115 is configured to receive a wake-up signal including an indication that the wake-up signal is addressed to the UE 115 in the form of a sequence of a pattern of power levels of the wake-up signal.

In block 1116, the UE 115 may receive an indication of one or more resources for monitoring for the wake-up signal. For example, a base station may transmit to the UE 115 an indication of one or more resources for monitoring for the wake-up signal.

In block 1118, the UE 115 may monitor one or more resources for transmission of the wake-up signal. The one or more resources may, for example, be frequency or time resources.

In block 1120, the UE may transmit an indication of one or more characteristics of an energy harvest circuit of the UE 115 to a base station. For example, in some embodiments, such an indication may include an indication of a power profile of an energy harvesting circuit of the UE 115, such as a power profile of a rectifier of the energy harvesting circuit. An indication of a power profile of an energy harvesting circuit may, for example, include an indication of a saturation threshold of the energy harvesting circuit an indication of a sensitivity threshold of the energy harvesting circuit, and other indications. In some embodiments, the indication of one or more characteristics of the energy harvesting circuit of the UE 115 may include an indication of a sequence that a passive envelope detector of an energy harvesting circuit of the UE 115 is configured to detect or an indication of a pattern of power levels of an energy harvesting circuit associated with the UE In block 1122, the UE 115 may, in some embodiments, use a passive envelope detector to compare a sequence of an indication that a wake-up signal is addressed to the UE with a second sequence. For example, if a wake-up signal includes a sequence indicating a UE to which the wake-up signal is addressed, the UE 115 may use a passive envelope detector to determine whether the sequence is addressed to the UE 115 by comparing the sequence of the wake-up signal with a second sequence associated with the UE 115. The passive envelope detector may, for example, be a passive envelope detector of an energy harvesting circuit of the UE 115. For example, the UE 115 may use a passive envelope detector to compare a sequence of a wake-up signal received at block 1102 of the method 1100 of FIG. 11A with a second sequence.

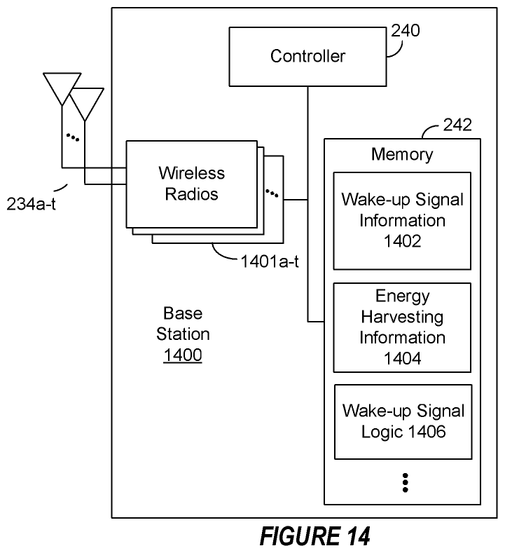

FIG. 12A is a flow diagram illustrating an example process 1200 that supports wake-up signal functionality for energy harvesting UEs according to one or more aspects. Operations of the process 1200 may be performed by a base station, such as the base station 105 described above with reference to FIGS. 1-2 and 4 or a base station as described with reference to FIG. 14. For example, example operations of the process 1200 may enable the base station 105 to generate and transmit wake-up signals to energy harvesting UEs.

In block 1202, the base station 105 may receive an indication of one or more characteristics of an energy harvesting circuit of a UE. For example, such an indication many be the indication described with respect to block 1120 of FIG. 11B. In some embodiments, the base station 105 may determine an indication associated with the UE for inclusion in a transmitted wake-up signal based on the indication of the one or more characteristics of the energy harvesting circuit of the UE. For example, the base station 105 may determine a sequence or pattern of power levels for inclusion in a wake-up signal to indicate that the wake-up signal is addressed to a particular UE based on characteristics of an energy harvesting circuit of the UE.

In block 1204, the base station 105 may transmit a wake-up signal including an indication that the wake-up signal is addressed to the UE. For example, the base station 105 may transmit a wake-up signal including an indication as described with respect to blocks 1102 of FIG. 11A. In some embodiments, after transmitting the wake-up signal, the base station 105 may transmit information on one or more resources for reception by the UE following transmission of the wake-up signal.

FIG. 12B is a flow diagram illustrating an example process 1210 that supports wake-up signal functionality for energy harvesting UEs according to one or more aspects. Operations of the process 1210 may be performed by a base station, such as the base station 105 described above with reference to FIGS. 1-2 and 4 or a base station as described with reference to FIG. 14. For example, example operations of the process 1210 may enable the base station 105 to generate and transmit wake-up signals to energy harvesting UEs. In some embodiments, operations of the process 1210 may be performed along with operations of the process 1200 by a base station 105. For example, the operations of blocks 1212-1216 of FIG. 12B may be performed prior to the operations of blocks 1202-1204 of FIG. 12A.

In block 1212, the base station 105 may transmit one or more reference signals. For example, the base station 105 may transmit one or more reference signals to a UE for measurement by the UE to determine a best wake-up signal mode for the UE.

In block 1214, the base station 105 may receive an indication of a wake-up signal mode associated with measurements of the one or more reference signals. For example, the base station 105 may receive an indication of a wake-up signal mode selected by the UE based on one or more measurements of the reference signal. The base station 105 may determine an indication that a wake-up signal is addressed to a particular UE for inclusion in a wake-up signal based on the received indication of the wake-up signal mode of the UE In block 1106, the base station 105 may transmit an indication of one or more resources for monitoring for the wake-up signal. For example, the base station may determine one or more resources for transmission of a wake-up signal to a UE and may transmit an indication of the determined resources to the UE.

FIG. 13 is a block diagram of an example UE 1300 that supports wake-up signal functionality for energy harvesting UEs according to one or more aspects. The UE 1300 may be configured to perform operations, including the blocks of the process 1100 described with reference to FIG. 11A and the process 1110 described with reference to FIG. 11B. In some implementations, the UE 1300 includes the structure, hardware, and components shown and described with reference to the UE 115 of FIG. 2 or 5. For example, the UE 1300 includes the controller 280, which operates to execute logic or computer instructions stored in the memory 282, as well as controlling the components of the UE 1300 that provide the features and functionality of the UE 1300. The UE 1300, under control of the controller 280, transmits and receives signals via wireless radios 1301a-r and the antennas 252a-r. The wireless radios 1301a-r include various components and hardware, as illustrated in FIG. 2 for the UE 115, including the modulator and demodulators 254a-r, the MIMO detector 256, the receive processor 258, the transmit processor 264, and the TX MIMO processor 266. In some embodiments, the UE 1300 may include the structure, hardware, and components shown and described with respect to energy harvesting device 300 of FIG. 3 and energy harvesting circuit 400 of FIG. 4.

As shown, the memory 282 may include wake-up signal information 1302 and energy harvesting information 1304. The wake-up signal information 1302 may correspond to wake-up signal information 510 of FIG. 5. The energy harvesting information 1304 may correspond to energy harvesting information 512 of FIG. 5. The UE 600 may receive signals from or transmit signals to one or more network entities, such as the base station 105 of FIGS. 1-2 and 5 or a base station as illustrated in FIG. 14.

In some implementations, the UE 1300 may be configured to perform the process 1100 of FIG. 11A and the process 1110 of FIG. 11B. To illustrate, the UE 1300 may execute, under control of the controller 280, the wake-up signal logic 1306 stored in the memory 282. The execution environment of the wake-up signal logic 1306 provides the functionality to perform at least the operations in blocks 1102-1104 and blocks 1112-1122.

FIG. 14 is a block diagram of an example base station 1400 that supports wake-up signal functionality for energy harvesting UEs according to one or more aspects. The base station 1400 may be configured to perform operations, including the blocks of the process 1200 described with reference to FIG. 12A and the process 1210 described with reference to FIG. 12B. In some implementations, the base station 1400 includes the structure, hardware, and components shown and described with reference to the base station 105 of FIGS. 1-2 and 5. For example, the base station 1400 may include the controller 240, which operates to execute logic or computer instructions stored in the memory 242, as well as controlling the components of the base station 1400 that provide the features and functionality of the base station 1400. The base station 1400, under control of the controller 240, transmits and receives signals via wireless radios 701a-t and the antennas 234a-t. The wireless radios 1401a-t include various components and hardware, as illustrated in FIG. 2 for the base station 105, including the modulator and demodulators 232a-t, the transmit processor 220, the TX MIMO processor 230, the MIMO detector 236, and the receive processor 238.

As shown, the memory 242 may include wake-up signal information 1402 and energy harvesting information 1404. The wake-up signal information 1402 may correspond to wake-up signal information 526 of FIG. 5. The energy harvesting information 1404 may correspond to energy harvesting information 528 of FIG. 5. The base station 1400 may receive signals from or transmit signals to one or more UEs, such as the UE 115 of FIGS. 1-2 and 5 or the UE 1300 of FIG. 13.

In some implementations, the base station 1400 may be configured to perform the process 1200 of FIG. 12A and the process 1210 of FIG. 12B. To illustrate, the base station 1400 may execute, under control of the controller 240, the wake-up signal logic 1406 stored in the memory 242. The execution environment of the wake-up signal logic 1406 provides the functionality to perform at least the operations in blocks 1202-1204 and 1212-1216.

It is noted that one or more blocks (or operations) described with reference to FIGS. 11A-B and 12A-B may be combined with one or more blocks (or operations) described with reference to another of the figures. For example, one or more blocks (or operations) of FIG. 11A may be combined with one or more blocks (or operations) of FIG. 12A. As another example, one or more blocks associated with FIGS. 11A-B and 12A-B may be combined with one or more blocks (or operations) associated with FIGS. 1, 2, 3, 4, or 5. Additionally, or alternatively, one or more operations described above with reference to FIG. 1, 2, 3, 4 or 5 may be combined with one or more operations described with reference to FIG. 13 or 14.

In one or more aspects, techniques for supporting wake-up signal functionality for energy harvesting UEs may include additional aspects, such as any single aspect or any combination of aspects described below or in connection with one or more other processes or devices described elsewhere herein. In a first aspect, supporting wake-up signal functionality for energy harvesting UEs may include an apparatus, such as a UE, configured to receive, from a network entity, a wake-up signal including a first indication that the wake-up signal is addressed to the UE, wherein the first indication is associated with one or more characteristics of an energy harvesting circuit of the UE and monitor, in response to the first indication that the wake-up signal is addressed to the UE, one or more first resources. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, alone or in combination with the first aspect, the apparatus may be further configured to transmit, to the network entity, a second indication of the one or more characteristics of the energy harvesting circuit of the UE.

In a third aspect, alone or in combination with one or more of the first aspect or second aspect, the apparatus may be further configured to receive, from the network entity, one or more reference signals, transmit, to the network entity, a third indication of a wake-up signal mode associated with measurements of the one or more reference signals, receive, from the network entity, a fourth indication of one or more second resources for monitoring for the wake-up signal, and monitor for the wake-up signal in the one or more second resources.

In a fourth aspect, alone or in combination with one or more of the first aspect through third aspect, the first indication comprises a first amplitude shifting key sequence associated with the UE.

In a fifth aspect, alone or in combination with one or more of the first aspect through fourth aspect, the apparatus may be further configured to use a passive envelope detector of the UE to compare the first amplitude shifting key sequence with a second amplitude shifting key sequence associated with the UE.

In a sixth aspect, alone or in combination with one or more of the first aspect through fifth aspect, the first indication comprises a pattern of a power of the wake-up signal.

In a seventh aspect, alone or in combination with one or more of the first aspect through the sixth aspect, the pattern of the power of the wake-up signal is associated with at least one of: a pattern of an operating zone of a rectifier of the energy harvesting circuit of the UE associated with the wake-up signal being passed through the rectifier, the power of the wake-up signal exceeding a first power threshold at a first time period, the power of the wake-up signal exceeding a second power threshold for a first length of time, the power of the wake-up signal being within a first range at a second time period and within a second range at a third time period, or the power of the wake-up signal crossing a first threshold at a first time.

In an eighth aspect, alone or in combination with one or more of the first through the seventh aspect, the pattern of the power of the wake-up signal is further associated with the power of the wake-up signal crossing a second threshold at a second time.

In a ninth aspect, alone or in combination with one or more of the first through the eighth aspect, the first threshold is different than the second threshold.

In one or more aspects, techniques for supporting wake-up signal functionality for energy harvesting UEs may include additional aspects, such as any single aspect or any combination of aspects described below or in connection with one or more other processes or devices described elsewhere herein. In a tenth aspect, supporting wake-up signal functionality for energy harvesting UEs may include an apparatus configured to receive, from a UE, a first indication of one or more characteristics of an energy harvesting circuit of the UE and transmit, to the UE, a wake-up signal including a second indication that the wake-up signal is addressed to the UE, wherein the first indication is associated with the one or more characteristics of the energy harvesting circuit of the UE. Additionally, the apparatus may perform or operate according to one or more aspects as described below. In some implementations, the apparatus includes a wireless device, such as a base station. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communications may include one or more operations described herein with reference to the apparatus.

In an eleventh aspect, alone or in combination with the tenth aspect, the apparatus may be further configured to transmit, to the UE, one or more reference signals, receive, from the UE, a third indication of a wake-up signal mode associated with measurements of the one or more reference signals, and transmit, to the UE, a fourth indication of one or more resources for monitoring for the wake-up signal, wherein the wake-up signal is transmitted on the one or more resources.

In a twelfth aspect, alone or in combination with one or more of the tenth aspect through the eleventh aspect, the first indication comprises a first amplitude shifting key sequence associated with the UE.

In a thirteenth aspect, alone or in combination with one or more of the tenth aspect through the twelfth aspect, the first indication comprises a pattern of a power of the wake-up signal.

In a fourteenth aspect, alone or in combination with the tenth through the thirteenth aspect, the pattern of the power of the wake-up signal is associated with at least one of: a pattern of an operating zone of a rectifier of the energy harvesting circuit of the UE associated with the wake-up signal being passed through the rectifier, the power of the wake-up signal exceeding a first power threshold at a first time period, the power of the wake-up signal exceeding a second power threshold for a first length of time, the power of the wake-up signal being within a first range at a second time period and within a second range at a third time period, or the power of the wake-up signal crossing a first threshold at a first time.

In a fifteenth aspect, alone or in combination with the tenth through fourteenth aspect, the pattern of the power of the wake-up signal is further associated with the power crossing a second threshold at a second time.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5 and 13-14 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a user equipment (UE), the method comprising:
receiving, from a network entity, a wake-up signal including a first indication that the wake-up signal is addressed to the UE, wherein the first indication is associated with one or more characteristics of an energy harvesting circuit of the UE; and
monitoring, in response to the first indication that the wake-up signal is addressed to the UE, one or more first resources.

2. The method of claim 1, further comprising;
transmitting, to the network entity, a second indication of the one or more characteristics of the energy harvesting circuit of the UE.

3. The method of claim 1, further comprising:
receiving, from the network entity, one or more reference signals;
transmitting, to the network entity, a third indication of a wake-up signal mode associated with measurements of the one or more reference signals;
receiving, from the network entity, a fourth indication of one or more second resources for monitoring for the wake-up signal; and
monitoring for the wake-up signal in the one or more second resources.

4. The method of claim 1, wherein the first indication comprises a first amplitude shifting key sequence associated with the UE.

5. (canceled)

6. The method of claim 1, wherein the first indication comprises a pattern of a power of the wake-up signal.

7. (canceled)

8. (canceled)

9. (canceled)

10. A user equipment (UE) comprising:
a memory; and
at least one processor coupled with the memory and operable to:
receive, from a network entity, a wake-up signal including a first indication that the wake-up signal is addressed to the UE, wherein the first indication is associated with one or more characteristics of an energy harvesting circuit of the UE ; and
monitor, in response to the first indication that the wake-up signal is addressed to the UE, one or more first resources.

11. The UE of claim 10, wherein the at least one processor is further operable to:
transmit, to the network entity, a second indication of the one or more characteristics of the energy harvesting circuit of the UE.

12. The UE of claim 10, wherein the at least one processor is further operable to:
receive, from the network entity, one or more reference signals;
transmit, to the network entity, a third indication of a wake-up signal mode associated with measurements of the one or more reference signals;
receive, from the network entity, a fourth indication of one or more second resources for monitoring for the wake-up signal; and
monitor for the wake-up signal in the one or more second resources.

13. The UE of claim 10, wherein the first indication comprises a first amplitude shifting key sequence associated with the UE.

14. The UE of claim 13, wherein the at least one processor is further operable to:
use a passive envelope detector of the UE to compare the first amplitude shifting key sequence with a second amplitude shifting key sequence associated with the UE.

15. The UE of claim 10, wherein the first indication comprises a pattern of a power of the wake-up signal.

16. The UE of claim 15, wherein the pattern of the power of the wake-up signal is associated with at least one of:
a pattern of an operating zone of a rectifier of the energy harvesting circuit of the UE associated with the wake-up signal being passed through the rectifier;
the power of the wake-up signal exceeding a first power threshold at a first time period;
the power of the wake-up signal exceeding a second power threshold for a first length of time;
the power of the wake-up signal being within a first range at a second time period and within a second range at a third time period; or the power of the wake-up signal crossing a first threshold at a first time.

17. The UE of claim 16, wherein the pattern of the power of the wake-up signal is further associated with the power crossing a second threshold at a second time.

18. The UE of claim 17, wherein the first threshold and the second threshold are different.

19. (canceled)

20. (canceled)

21. (canceled)

22. (canceled)

23. (canceled)

24. (canceled)

25. A network entity comprising:
a memory; and
at least one processor coupled with the memory and operable to:
receive, from a user equipment (UE), a first indication of one or more characteristics of an energy harvesting circuit of the UE; and
transmit, to the UE, a wake-up signal including a second indication that the wake-up signal is addressed to the UE, wherein the first indication is associated with the one or more characteristics of the energy harvesting circuit of the UE.

26. The network entity of claim 25, wherein the at least one processor is further operable to:
transmit, to the UE, one or more reference signals;
receive, from the UE, a third indication of a wake-up signal mode associated with measurements of the one or more reference signals; and
transmit, to the UE, a fourth indication of one or more resources for monitoring for the wake-up signal,
wherein the wake-up signal is transmitted on the one or more resources.

27. The network entity of claim 25, wherein the first indication comprises a first amplitude shifting key sequence associated with the UE.

28. The network entity of claim 25, wherein the first indication comprises a pattern of a power of the wake-up signal.

29. The network entity of claim 28, wherein the pattern of the power of the wake-up signal is associated with at least one of:
a pattern of an operating zone of a rectifier of the energy harvesting circuit of the UE associated with the wake-up signal being passed through the rectifier;
the power of the wake-up signal exceeding a first power threshold at a first time period;
the power of the wake-up signal exceeding a second power threshold for a first length of time;
the power of the wake-up signal being within a first range at a second time period and within a second range at a third time period; or the power of the wake-up signal crossing a first threshold at a first time.

30. The network entity of claim 29, wherein the pattern of the power of the wake-up signal is further associated with the power crossing a second threshold at a second time.
